(19) United States
(12) Patent Application Publication
(10) Pub. No.: US 2026/0339887 A1
(43) Pub. Date: Oct. 29, 2026

(54) DATA MIGRATION BETWEEN QUALITY MANAGEMENT SYSTEMS

(71) Applicant: Honeywell International Inc., Charlotte, NC (US)

(72) Inventors: Tom Rac, Manasquan, NJ (US); Shaun Vallejo, Red Bank, NJ (US)

(21) Appl. No.: 19/186,669

(22) Filed: Apr. 23, 2025

(51) Int. Cl. G06F 16/11

(52) U.S. Cl. CPC G06F 16/119

(57) ABSTRACT

Techniques for data migration between Quality Management Systems (QMSs) are disclosed. One or more data files in a standardized protocol format are parsed to extract a plurality of configuration elements in the standardized protocol format. An import strategy from a plurality of predefined import strategies based on a determined data type of each configuration element. A configuration element of the destination QMS corresponding to each of the plurality of extracted configuration elements is determined based on the selected import strategy. Each configuration element may be mapped to the corresponding configuration element of the destination QMS based on the determination. The destination QMS is configured by executing configuration scripts. The configuration of the destination QMS is validated to ensure compliance with predefined quality standards. A report indicating the mapping and configuration is generated based on the validation of the configuration.

### BACKGROUND

Generally, Quality Management Systems (QMSs) have been an important component of business operations across various industries, such as manufacturing, aerospace, automotive, life sciences, food and beverage industries, and the like. The QMSs are designed to enable organizations to manage and adhere to quality-related processes. In addition, the QMS also ensures regulatory compliances, mitigate risks, streamline processes, enhances analytics and enables continuous improvement in processes.

Typically, QMS includes various features, such as documentation control, Corrective and Preventive Actions (CAPA), audit management, Supplier Quality management, training management, risk management, nonconformance tracking, change control, and the like. In addition, QMSs have also developed extensive documentation, including standard operating procedures, validation protocols, and training materials. The extensive documentation is one of the key things for ensuring consistent quality processes across the organization and for ensuring regulatory compliance.

Conventionally, the QMSs were employed as on-premise solutions. In other words, the QMSs were employed in one or more systems at the facility (for example, industrial plant, warehouse, or the like) of the organization. With the advent of cloud technology, QMSs are also provided through cloud platforms. The provision of the QMSs through the cloud platforms makes authorized users access the QMSs at any location and at any time.

### SUMMARY

In the present subject matter, a system for migrating data into a destination Quality Management System (QMS) comprises a processing unit. The destination QMS may be, for example, an on-premise QMS, such as Trackwise. In another example, the destination QMS may be, for example, a cloud-based QMS, such as Trackwise Digital. The processing unit may receive one or more data files in a standardized protocol format. The standardized protocol may correspond to a descriptor language that encapsulates a plurality of elements of quality control processes. The processing unit may parse the received one or more data files to extract a plurality of configuration elements in the standardized protocol format. In an example, the extracted configuration elements may include workflow definitions, object definitions, and permission set definitions. The workflow definitions may include a defined sequence of stages and actions for quality control processes, including transition rules, fields, and configuration of fields for each stage. The object definitions may include a data structure representing a record type for quality control processes, including fields with defined data types, field attributes, audit trail configurations, and presentation layouts. The permission set definitions may include a collection of access rights and restrictions defining user actions within a quality management system, including read, write, and delete permissions for objects and fields, and access rights for workflow.

The processing unit may determine a data type of the each of the configuration elements based on metadata in the standardized protocol. The processing unit may select an import strategy from a plurality of predefined import strategies based on the determined data type. The processing unit may determine a configuration element of the destination QMS corresponding to each of the plurality of extracted configuration elements based on the selected import strategy and map each of the plurality of extracted configuration elements to the corresponding configuration element of the destination QMS based on the determination. The processing unit may generate configuration scripts in response to the mapping and configure the destination QMS by executing the configuration scripts. The processing unit may validate the configuration of the destination QMS to ensure compliance with predefined quality standards and generate a report indicating the mapping and configuration based on the validation of the configuration.

The processing unit may determine an import sequence based on an identification of the interdependencies and hierarchical relationships among the elements and may generate the configuration scripts based on the mapping and on the import sequence.

In an example, to parse, the processing unit may classify each field of the extracted configuration element according to a data type thereof and to map, the processing unit may select an appropriate data type of the field in the destination QMS based on the classification. The processing unit may identify complex fields that have nested records and may recursively process the identified complex fields to extract the nested records.

The processing unit may identify fields corresponding to each of the extracted configuration elements that require audit trailing. Further, the processing unit may import audit trail definitions associated with the fields. In addition, the processing unit may configure audit trail settings in the QMS based on the imported audit trail definitions.

The processing unit may determine if each of the extracted configuration elements is mapped to a corresponding configuration element of the destination QMS and may allow manual mapping of an extracted configuration element to a configuration element of the destination QMS. The allowing of the manual mapping may be based on the determination that the extracted configuration element is not automatically mapped to a corresponding configuration element of the destination QMS.

In an example, a method for for migrating data from a source Quality Management System (QMS). The method may include receiving, by a processor, a selection of configuration data to be exported from the source QMS. A plurality of configuration elements of the selected configuration data may be extracted by the processor from a database of the source QMS. The extracted configuration elements may include workflow definitions, object definitions, and permission set definitions. The workflow definitions may include a defined sequence of stages and actions for quality control processes, including transition rules, fields, and configuration of fields for each stage. The object definitions may include a data structure representing a record type for quality control processes, including fields with defined data types, field attributes, audit trail configurations, and presentation layouts. The permission set definitions may include a collection of access rights and restrictions defining user actions within a quality management system, including read, write, and delete permissions for objects and fields, and access rights for workflow.

In an example, for each of the plurality of extracted configuration elements, the method may include the following steps. A data type of the configuration element may be determined by the processor. A transformation strategy may be selected by the processor from a plurality of predefined transformation strategies based on the determined data type. The configuration element may be transformed, by the processor, into a standardized protocol format according to the selected transformation strategy and specification corresponding to the standardized protocol. The standardized protocol may correspond to a descriptor language that encapsulates a plurality of elements of quality control processes.

The method may include generating, by the processor, one or more data files that are standardized protocol-compliant. The one or more data files may include the transformed configuration elements. The method may include outputting, by the processor, the one or more data files for use in importing the configuration data into a destination QMS.

In an example, a non-transitory computer-readable medium may comprise instructions for migrating data between QMSs. The instructions may be executable by a processing resource to retrieve configuration data from a source QMS. The configuration data may include object definitions, workflow definitions, and permission set definitions corresponding to quality control processes. The instructions may be executable by the processing resource to receive a selection of configuration data to be exported from the source QMS and convert the selected configuration data into one or more JSON-based data files in response to the selection. The conversion may be based on a transformation strategy of a plurality of transformation strategies. The one or more JSON-based data files may be in a standardized protocol format. The standardized protocol may correspond to a JSON-based descriptor language that encapsulates a plurality of elements of quality control processes.

The instructions may be executable by the processing resource to store the converted one or more JSON-based data files and to identify a destination QMS. The instructions may be executable by the processing resource to parse the converted one or more JSON-based data files to determine a plurality of configuration elements and to determine a data type of each of the plurality of configuration elements based on metadata in the standardized protocol format. The instructions may be executable by the processing resource to select an import strategy from a plurality of predefined import strategies based on the determined data type and to transform each of the plurality of configuration elements from the standardized format into a format compatible with the destination QMS based on the selected import strategy. The instructions may be executable by the processing resource to present, via a user interface, options for mapping the transformed configuration elements to the destination QMS and to receive, via the user interface, user selections for mapping the transformed configuration elements. The instructions may be executable by the processing resource to configure the destination QMS based on the transformed configuration elements and the received user selections and to store a report corresponding to the mapping. The report may be usable in validation of the migration of the data from the source QMS to the destination QMS.

### BRIEF DESCRIPTION OF DRAWINGS

The detailed description is provided with reference to the accompanying figures. In the figures, the left-most digit(s) of a reference number identifies the figure in which the reference number first appears. The same numbers are used throughout the drawings to reference like features and components.

FIG. 1 illustrates a system for data migration between Quality Management Systems, according to an example implementation of the present subject matter.

FIG. 2 illustrates a system for data migration between Quality Management Systems, according to an example implementation of the present subject matter.

FIG. 3 illustrates a system for data migration between Quality Management Systems, according to an example implementation of the present subject matter.

FIG. 4 illustrates a system for data migration between Quality Management Systems, according to an example implementation of the present subject matter.

FIGS. 5a-5c illustrate a method for data migration between Quality Management Systems, according to an example implementation of the present subject matter.

FIGS. 6a-6b illustrate a method for data migration between Quality Management Systems, according to an example implementation of the present subject matter.

FIGS. 7a-7b illustrate a computing environment, implementing a non-transitory computer-readable medium for data migration between Quality Management Systems, according to an example implementation of the present subject matter.

### DETAILED DESCRIPTION

Conventionally, Quality Management Systems (QMSs) have been used across various industries to enable organizations to manage and adhere to quality-related processes. Oftentimes, the industries may want to migrate from one QMS platform to another QMS platform for various reasons, such as affordability, scalability, features offered, and the like. For instance, an aerospace organization may want to migrate from one on-premise QMS platform to another on-premise QMS platform due to provision of additional features that helps ensuring the regulatory requirement better. As another example, the organizations may want to migrate from an on-premise QMS platform to a cloud-based QMS platform. For instance, due to reduced maintenance and better scalability, a life sciences industry may want to switch from an on-premise QMS to a cloud-based QMS.

The migration of data from one QMS, such as a legacy QMS (an on-premise QMS) to another QMS, such as cloud-based QMS, has many difficulties, including significant technical and operational challenges. The replication of customized configurations provided by the legacy QMS is difficult. Further, extensive validation documentation is required while transforming from one QMS to another QMS.

Existing techniques for migration often require substantial manual intervention. Such manual migration of complex configurations is time consuming and resource consuming. For instance, a medical device manufacturer is planning to transition from one QMS to another QMS to benefit from enhanced data analytics capabilities. The transition involves technical migration and revalidation of the all the components of the QMS to comply with quality standards. The manual reconfiguration of the QMS and validation of each process can be time consuming and resource consuming. For example, if the legacy QMS includes numerous workflows, each element may need individual attention to ensure that the element functions correctly in the new QMS. This may require significant time and resources. In addition, such manual migration of the data struggles with customizations that are complex. Accordingly, the manual migration of data may not guarantee maintaining compliance subsequent to the migration. As an example, a medical device manufacturing organization has customized an on-premise QMS to include unique workflows and data fields to a medical device operation and consumer complaints. The customizations, such as specific fields for tracking medical device operation and consumer complaints, has to be accurately mapped and functional in a new QMS. The complexity increases when the custom fields are interconnected with other systems for consumer complaints. Any failure in accurately migrating the customizations leads to inefficient tracking and handling of consumer complaints. This may lead to a higher rate of product recalls.

Further, the process of transformation is also prone to errors. With stringent regulatory standards, such as the aerospace industries, life sciences industries, and the like, erroneous transformation would compromise data integrity and regulatory compliance. For instance, assume that a pharmaceutical company uses a legacy QMS to manage its quality processes, including compliance with regulatory requirements. In such a scenario, the QMS would have been customized over the years to align with specific regulatory requirements and internal workflows. In this regard, when migrating to a new QMS, every component of the legacy QMS′ configuration, including custom fields, workflows, and validation rules, may have to be precisely replicated or transformed to maintain compliance. In other words, if the QMS has a custom workflow for handling adverse event reports, every component, such as mandatory fields and specific user permissions at each step, and the like, may have to be accurately transferred to the new QMS. Any error in transferring these configurations could lead to non-compliance with regulatory requirements.

In addition, the financial and logistical burdens associated with migrating to a new QMS are higher. A large portion of the cost of migration is associated with recreating the validating the documentation and configurations in the new QMS. For instance, a drug manufacturing organization may plan to transition from an on-premise QMS to another QMS due to better scalability and integration capabilities. Accordingly, the drug manufacturing organization may include numerous customized fields, such as allergic reaction to the drug, consumer complaints, composition of the drug, and the like. Each field may have to be manually reconfigured and validated, which is a daunting task. Such extensive manual effort incurs significant cost and increases the budget of the company. Therefore, currently, there are complexities involved in migrating from one QMS to another QMS which include technical, regulatory, financial, and operational aspects. Accordingly, the conventional techniques for migration of data are inefficient and makes smooth and compliant migration a difficult task.

The present subject matter facilitates data migration between Quality Management Systems (QMSs). With the present subject matter, the migration of data between one QMS, such as an on-premise QMS, to another QMS, such as a cloud-based QMS, is easy, flexible, and time and resource-efficient.

In an example, the present subject matter relates to techniques for migration of data between Quality Management Systems (QMSs). In particular, the present subject matter relates to techniques for migration of data from a source QMS to a destination QMS. As an example, the source QMS may be an on-premise-based QMS, such as Trackwise, and the destination QMS may be a cloud-based QMS, such as Trackwise Digital.

The techniques use a standardized protocol format, for example, a JSON-based descriptor language, designed to encapsulate various elements of quality control processes. For the process of export of the configuration data from the source QMS, configuration data from the source QMS may be received. From the received configuration data, configuration elements may be extracted. The extracted configuration elements from the source QMS may include workflow definitions (comprising stages, actions, transition rules, fields, field configurations, and the like), object definitions (data structures representing record types, including fields, data types, attributes, audit trail configurations, presentation layouts, and the like), and permission set definitions (access rights, restrictions for users, and the like).

The extracted configuration elements may be transformed into a standardized protocol format. In this regard, for the transformation, a data type of each configuration element may be identified. An appropriate transformation strategy for the corresponding data type may be chosen. Based on the selected transformation strategy, the configuration elements may be converted into the standardized protocol format. For instance, based on the data type, a transformation strategy may be chosen for each field. In an example, if there are complex fields with nested records, recursive processing of the nested records is performed to identify transformation strategy. Subsequently, based on the transformation strategy, configuration elements are transformed into standardized protocol-compliant JSON files.

During the import process of importing the configuration data into a destination QMS, the standardized protocol-compliant files are parsed to extract configuration elements. Data types of the configuration elements may be identified based on metadata and appropriate import strategies may be selected.

In response to the selection of the appropriate import strategy, extracted configuration elements to may be mapped to corresponding configuration elements in the destination QMS. In this regard, a user interface presents options for mapping transformed elements and allows for user input in the migration process. For example, if there are unmapped elements during the migration process, options may be provided to a user, such as an administrator, to allow manual mapping of the unmapped elements. The options may be provided using a User Interface. The options may include mapping of the configuration elements corresponding to the source QMS to existing configuration elements of the destination QMS. In another example, the options may include creation of new configuration elements in the destination QMS and allow mapping of the configuration elements corresponding to the source QMS to the newly created configuration elements in the destination QMS.

In an example, the techniques identify interdependencies and hierarchical relationships among elements and determines an optimal import sequence. Based on the import sequence, configuration scripts are generated and executed to set up the destination QMS. Further, a validation step is performed to ensure compliance with predefined quality standards. Based on the validation, a detailed report of the migration process may be generated. The report includes details of each configuration element mapped, format of the configuration elements in the source QMS, format of the configuration elements in the destination QMS, the option of the mapping selected by the user for each configuration element, a list of successfully migrated configuration elements in the destination QMS, a list of configuration elements that failed the migration into the destination QMS, and the like.

The present subject matter enables simple, easy, and efficient migration of data between QMSs. Further, the present subject matter ensures accurate migration of data and enhanced compliance and data integrity. The present subject matter facilitates handling highly customized QMSs. The present subject matter also reduces substantial manual intervention required for validation of the migration. The present subject matter facilitates smooth and compliant migration between QMSs. The present subject matter allows migration between different QMS systems without needing to develop entirely new tools for each system pair. In other words, the present subject matter eliminates work effort of developing migration utilities, as only the export or import component needs to be developed for a new system.

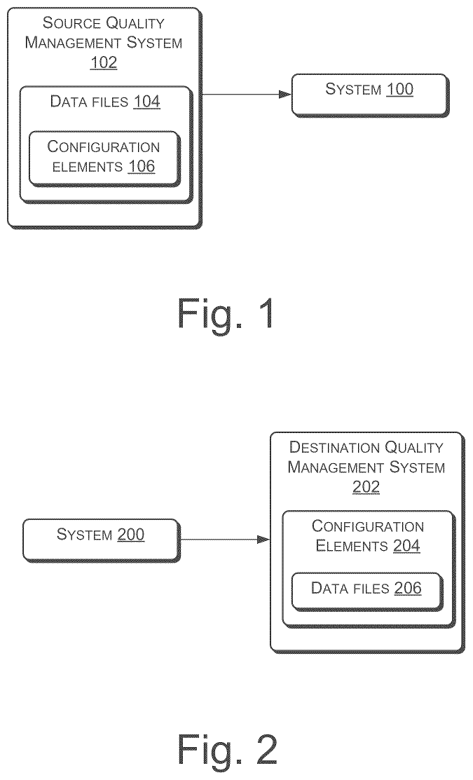

The present subject matter is further described with reference to FIGS. 1-7b. It should be noted that the description and figures merely illustrate principles of the present subject matter. Various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

FIG. 1 illustrates a system 100 for data migration between Quality Management Systems (QMSs), according to an example implementation of the present subject matter. Herein, the system 100 is explained with reference to migrating data from a source QMS 102. In an example, an industry may want to migrate data from the source QMS 102 to a destination QMS (not shown in FIG. 1). The source QMS 102 may be, for example, an on-premise QMS, such as Trackwise. Hereinafter, the source QMS 102 may be explained with reference to the on-premise QMS. Similarly, the destination QMS may be, for example, a cloud-based QMS, such as Trackwise Digital. Hereinafter, the destination QMS will be explained with reference to the cloud-based QMS. The source QMS 102 may include data files 104 that correspond to a quality control process. For instance, a medical device industry may include various quality control processes that may have to be adhered to corresponding to the production of a medical device, including regulatory compliances, mitigation of risk, and the like. In this regard, the source QMS 102 may include data files that correspond to the quality control processes. The data files 104 may be stored in a database (not shown in FIG. 1) of the source QMS 102.

In an example, the data files 104 may include configuration elements 106 that correspond to the quality control processes. The configuration elements 106 may include workflow definitions, object definitions, and permission set definitions. The workflow definitions may include a defined sequence of stages for a quality control process, transition rules between stages, actions to be performed at each stage, field configuration corresponding to various fields specific to each stage, and the like. For instance, assume that a medical device industry has received a complaint related to a product. The complaint goes through a life cycle, which includes investigating the complaint, designing, reporting to the regulatory authorities, recall (if required), and the like. The life cycle may correspond to the work flow definitions. The object definitions may correspond to a data structure representing a specific quality management record type and may include a set of fields with defined data types and field attributes. The data types may include string, date, numeric, and the like. The field attributes may correspond to required fields, pick list values fields, and the like. In some scenarios, some objects may correspond to fields that require audit trailing for complying with regulatory requirements. In some scenarios, the object definitions may also include presentation layouts for fields of the objects.

The permission set definitions may include a collection of access rights and restrictions that define actions a user or role can perform within the QMS. The permission set definitions may include read, write, and deletion permissions for specific objects and fields. The access right may correspond to initiation, progress, and approval of workflow stages. The permission set definitions may include visibility rules for different sections or fields within an object.

Each of the configuration elements 106 may have to be migrated to the destination QMS. In this regard, the system 100 may enable migrating the configuration elements 106 to the destination QMS. The system 100 may include a microprocessor, a microcomputer, a microcontroller, a digital signal processor, a central processing unit, a state machine, a logic circuitry, or a device that manipulates signals based on operational instructions. Among other capabilities, the system 100 may fetch and execute computer-readable instructions stored in a memory, such as a volatile memory or a non-volatile memory, of the system 100. The system 100 may include a device (not shown in FIG. 1), such as a display device, for displaying various things, such as a User Interface (UI) corresponding to migration, as will be explained later. The system 100 may execute an Application Programming Interface (API) to extract the configuration elements 106.

During the operation, the system 100 may receive a selection of configuration data to be exported from the source QMS 102. The configuration data may correspond to the data files 104 and may include one or more configuration elements 106. To receive a selection, the system 100 may display the configuration data to a user using the UI. The user may choose one or more of the data files from the data files 104 for the migration. In response to the receipt of the selection, the system 100 may extract the configuration elements from the selected one or more data files.

The system 100 may determine data type of the extracted configuration elements. Based on the determined data type, the system 100 may select a transformation strategy from a plurality of predefined transformation strategies. The plurality of predefined transformation strategies may correspond to a standardized protocol. The standardized protocol may be a descriptor language that encapsulates a plurality of elements of quality control processes. In an example, the standardized protocol may be a descriptor language that may define format for each configuration element of a QMS to be able to adhere to regulatory requirements and may facilitate migration from one QMS to another QMS. The standardized protocol may have a specification according to the regulatory requirements to facilitate the migration.

The system 100 may transform each selected configuration element into a standardized protocol format according to the selected transformation strategy and specification corresponding to the standardized protocol. The system 100 may generate one or more data files that are standardized protocol-compliant based on the transformation with the one or more data files having the transformed configuration elements. The generated one or more data files may be output for use in importing the configuration data into a destination QMS. The generated one or more data files may be, for example, in the Javascript Obect Notation (JSON) format.

FIG. 2 illustrates a system 200 for data migration between QMSs, according to an example implementation of the present subject matter. Herein, the system 200 is explained with reference to migrating data to a destination QMS 202 from a source QMS. The source QMS may be, for example, the source QMS 102. In an example, an industry may want to migrate data from the source QMS (not shown in FIG. 1) to the destination QMS 202. The destination QMS 202 may be, for example, a cloud-based QMS, such as Trackwise Digital. Hereinafter, the destination QMS 202 may be explained with reference to the cloud-based QMS. Similarly, the source QMS may be, for example, an on-premise QMS, such as Trackwise Digital. Hereinafter, the destination QMS 202 will be explained with reference to the cloud-based QMS. The destination QMS 202 may have a specific format for storing data files 204 that correspond to a quality control process. For instance, a destination QMS for a medical device industry may include various quality control processes that may have to be adhered to corresponding to the production of a medical device, including regulatory compliances, mitigation of risk, and the like. In this regard, the destination QMS 202 may have a specific format for the data files 204 that correspond to the quality control processes. The data files 204 in the specific format may be stored in a database (not shown in FIG. 2) of the destination QMS 202. The data files 204 may include the configuration elements 206.

In particular, the configuration elements 206 may correspond to a specific format. The configuration elements 206 may correspond to the quality control processes. The configuration elements 206 may correspond to workflow definitions, object definitions, and permission set definitions. For instance, a field that has text may correspond to a string field.

Each of the configuration elements corresponding to the source QMS, such as the source QMS 102, may have to be migrated to the destination QMS 202. In this regard, the system 200 may enable migrating the configuration elements corresponding to the source QMS to the destination QMS 202. The system 200 may include a microprocessor, a microcomputer, a microcontroller, a digital signal processor, a central processing unit, a state machine, a logic circuitry, or a device that manipulates signals based on operational instructions. Among other capabilities, the system 200 may fetch and execute computer-readable instructions stored in a memory, such as a volatile memory or a non-volatile memory, of the system 200. The system 200 may include a device (not shown in FIG. 1), such as a display device, for displaying various things, such as a User Interface (UI) corresponding to migration, as will be explained later. The system 200 may execute an Application Programming Interface (API) to import the configuration elements corresponding to the source QMS into the destination QMS 202.

During the operation, the system 200 may receive one or more data files in the standardized protocol format. The one or more data files may be in JSON-based. The data files in the standardized protocol format may be sent by the system 100. The system 200 may parse the received one or more data files. The parsing may be performed to extract the plurality of configuration elements corresponding to the source QMS. The system 200 may determine a data type of each of the configuration elements based on metadata in the standardized protocol. The metadata may define the configuration elements. For instance, assume that the configuration element corresponds to an object corresponding to a picklist. The metadata may indicate values of the picklist that are valid. Based on the determined data type, an import strategy for the importing may be selected. The import strategy may be selected from a plurality of predefined import strategies. The plurality of predefined import strategies may correspond to different data types. For instance, one import strategy may correspond to the datatype string. Another import strategy may correspond to the datatype numeric. Based on the selected import strategy, the system 200 may determine a configuration element 206 of the destination QMS 202 corresponding to each of the plurality of extracted configuration elements based on the selected import strategy.

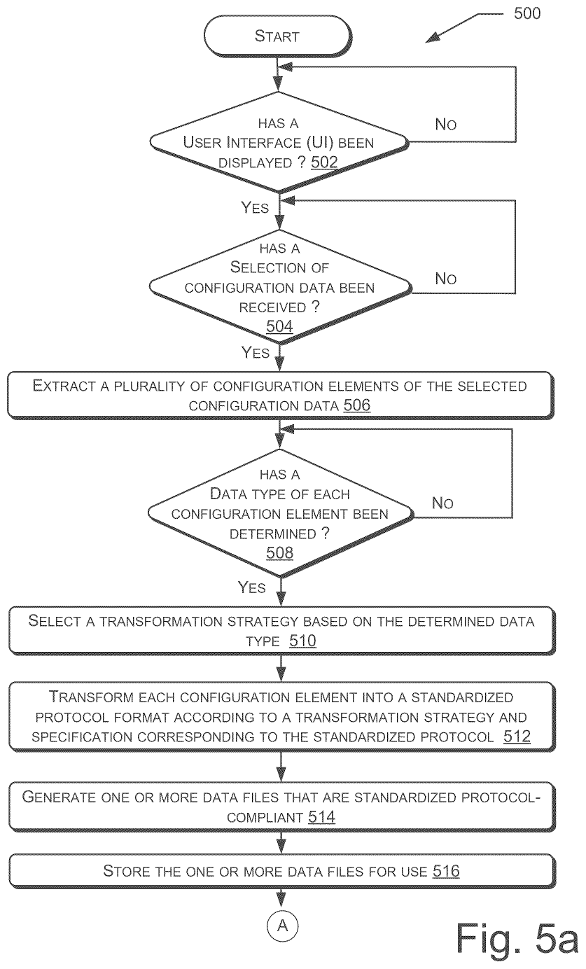

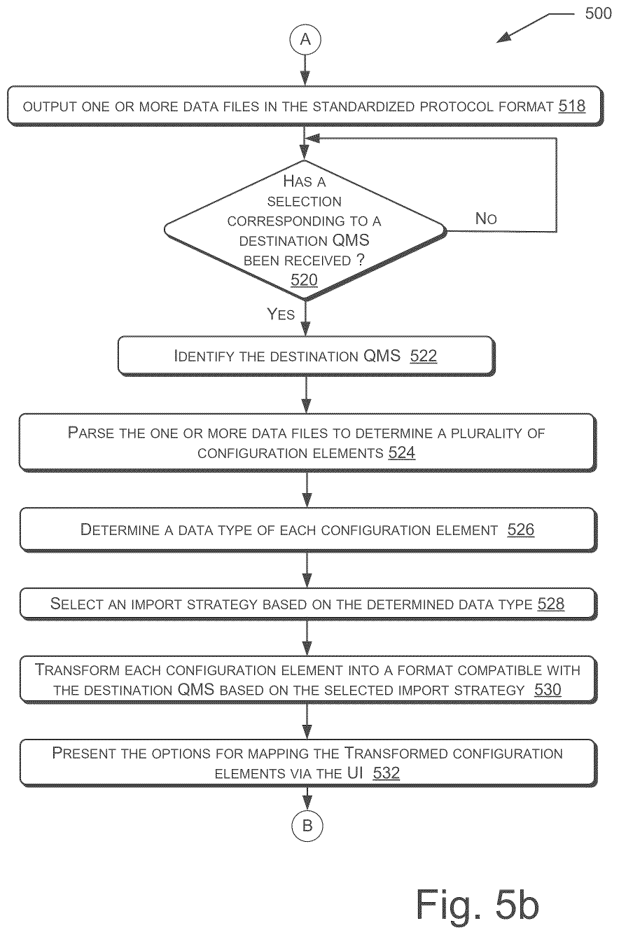

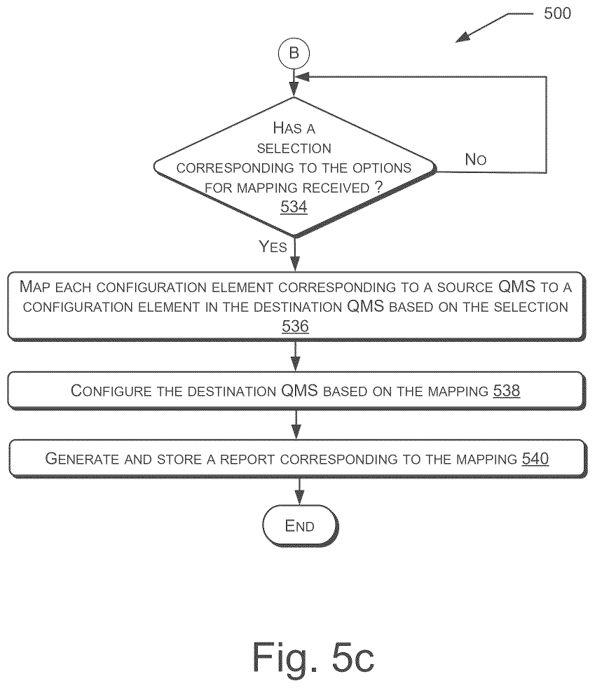

The system 200 may map each of the plurality of extracted configuration elements to the corresponding configuration element 206 of the destination QMS 202 based on the determination of the configuration element 206 of the destination QMS 202. In an example, the system 200 may present options via the UI for mapping the transformed configuration elements 206 to the destination QMS 202. The options may include manual mapping or automatic mapping, as will be explained in detail with reference to FIGS. 5a-5c.

The system 200 may generate configuration scripts in response to the mapping. The system 200 may configure the destination QMS 202 by executing the configuration scripts. The configuration of the destination QMS 202 may be validated to ensure compliance with predefined quality standards. The system 200 may generate a report indicating the mapping and configuration based on the validation of the configuration. The report may include details of each configuration element mapped, format of the configuration elements in the source QMS, format of the configuration elements 206 in the destination QMS 202, the option of the mapping selected by the user for each configuration element, a list of successfully migrated configuration elements in the destination QMS, a list of configuration elements that failed the migration into the destination QMS, or a combination thereof.

In the above examples, migrating data from a source QMS and migrating data into a destination QMS are explained as being performed by two different systems, such as the system 100 and the system 200. However, in other example, a single system can migrate data from the source QMS to the destination QMS.

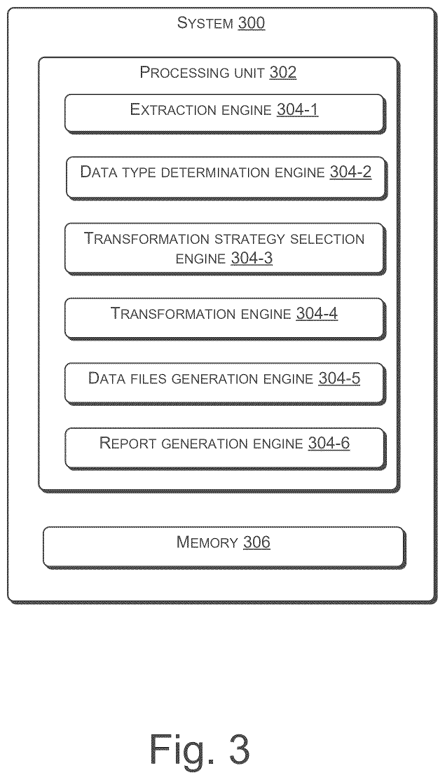

FIG. 3 illustrates a system 300 for data migration between QMSs, according to an example implementation of the present subject matter. Herein, the system 300 facilitates migration of data from the source QMS. The source QMS may correspond to the source QMS 102. The system 300 may correspond to the system 100.

The system 300 may be a computing device that has processing capabilities, such as a server, a desktop, a laptop, a tablet, a mobile phone, or the like. For instance, the system 300 may include a processing unit 302. The processing unit 302 may be, for example, a microprocessor, a microcomputer, a microcontroller, a digital signal processor, a central processing unit, a state machine, a logic circuitry, or a device that manipulates signals based on operational instructions. Among other capabilities, the processing unit 302 may fetch and execute computer-readable instructions stored in a memory 306, such as a volatile memory or a non-volatile memory, of the system 300.

The processing unit 302 may run at least one operating system and other applications and services. The system 300 can also include an interface and the memory 306. The processing unit 302, amongst other capabilities, may be configured to fetch and execute computer-readable instructions stored in the memory. The processing unit 302 may be implemented as one or more microprocessors, microcomputers, microcontrollers, digital signal processors, central processing units, state machines, logic circuitries, and/or any devices that manipulate signals based on operational instructions. The functions of the various elements shown in the figure, including any functional blocks labelled as “processing unit”, may be provided through the use of dedicated hardware as well as hardware capable of executing machine readable instructions.

When provided by the processing unit 302, the functions may be provided by a single dedicated processor, by a single shared processor, or by a plurality of individual processors, some of which may be shared. Moreover, explicit use of the term “processing unit” should not be construed to refer exclusively to hardware capable of executing machine readable instructions, and may implicitly include, without limitation, digital signal processor (DSP) hardware, network processor, application specific integrated circuit (ASIC), field programmable gate array (FPGA), read only memory (ROM) for storing machine readable instructions, random access memory (RAM), non-volatile storage. Other hardware, conventional and/or custom, may also be included.

The interface may include a variety of machine-readable instructions-based interfaces and hardware interfaces that allow the cloud communication device to interact with different entities, such as the processing unit 302. Further, the interface may enable the components of the system 300 to communicate with other cloud servers, web servers, and external repositories. The interface may facilitate multiple communications within a wide variety of networks and protocol types, including wired network, wireless networks, wireless Local Area Network (WLAN), RAN, satellite-based network, and the like.

The memory 306 may be coupled to the processing unit 302 and may, among other capabilities, provide data and instructions for generating different requests. The memory 306 can include any computer-readable medium known in the art including, for example, volatile memory, such as static random-access memory (SRAM) and dynamic random-access memory (DRAM), and/or non-volatile memory, such as read only memory (ROM), erasable programmable ROM, flash memories, hard disks, optical disks, and magnetic tapes. The memory 306 may include a database (not shown in FIG. 3) that may include data files, such as the data files 104. Further, the system 300 may include a display device. The display device may correspond to the display device of the system 100. The display device may display the UI.

Further, the system 300 may include one or more engines 304-1-304-6. The engines 304-1-304-6 may include routines, programs, objects, components, data structures, and the like, which perform particular tasks or implement particular abstract data types. Further, the engines 304-1-304-6 may be implemented in hardware, instructions executed by a processing unit, or by a combination thereof.

In an implementation, the engines 304-1-304-6 may be machine-readable instructions which, when executed by the processing unit, perform any of the described functionalities. The machine-readable instructions may be stored on an electronic memory device, hard disk, optical disk or other machine-readable storage medium or non-transitory medium. In one implementation, the machine-readable instructions can also be downloaded to the storage medium via a network connection.

The engines 304-1-304-6 may perform different functionalities. The engines 304-1-304-6 may include an extraction engine 304-1, a data type determination engine 304-2, a transformation strategy selection engine 304-3, a transformation engine 304-4, a data files generation engine 304-5, and a report generation engine 304-6. The extraction engine 304-1 may receive a selection of the configuration data from a user. The configuration data may be presented to the user using the UI. The extraction engine 304-1 may extract the plurality of configuration elements of the selected configuration data from the database of the source QMS. The data type determination engine 304-2 may determine the data type of each of the extracted configuration elements.

The transformation strategy selection engine 304-3 may select a transform strategy from a plurality of predefined transformation strategies based on the determined data type. The transformation engine 304-4 may transform each configuration element into a standardized protocol format according to the selected transformation strategy and specification corresponding to the standardized protocol. The transformation of the configuration element may include applying a set of transformation rules that convert the configuration element into a standardized protocol.

In an example, the set of transformation rules may include mapping a name of each filed to a standardized protocol-compliant name and determining a type of each field and may capture metadata associated with each field.

In an example, the configuration elements may include workflow definitions, object definitions, and permission set definitions. For each extracted workflow definition, the transformation engine 304-4 may determine workflow stages and the corresponding field configurations. The transformation engine 304-4 may transform the determined workflow stages and the corresponding field configurations to the standardized protocol format. For each extracted object definition, the transformation engine 304-4 may identify field types, attributes, and presentation layouts. The transformation engine 304-4 may transform the identified field types, attributes, and presentation layouts to the standardized protocol format. For each extracted permission set definition, the transformation engine 304-4 may ascertain, by the processor, user roles and associated access rights and may transform, by the processor, the ascertained user roles and access rights to the standardized protocol format.

In an example, if the extracted configuration element includes complex fields with the nested records, the transformation engine 304-4 may cache related record information to optimize processing of the nested records. In an example, the transformation engine 304-4 may identify complex fields in the configuration data and may recursively process the identified complex fields to extract nested records. Prior to the transformation of each configuration element, the transformation engine 304-4 may also verify completeness of the extracted configuration element.

The data files generation engine 304-5 may enable generation of the one or more data files that are standardized protocol-compliant. The one or more data files may include the configuration elements. The one or more data files may be, for example, JSON-based. The data files generation engine 304-5 may output the one or more data files for use in importing the configuration data into the destination QMS. The report generation engine 304-6 may generate a report that may include details corresponding to the transformation of the configuration elements and format of the configuration elements in the source QMS.

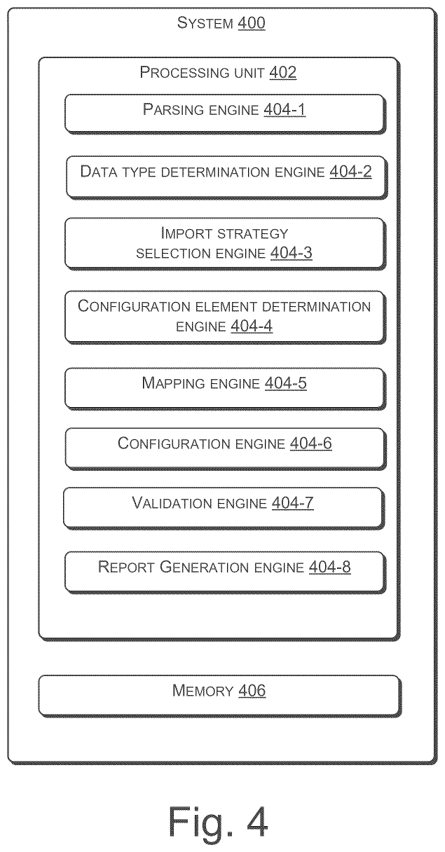

FIG. 4 illustrates a system 400 for data migration between QMSs, according to an example implementation of the present subject matter. Herein, the system 400 facilitates migration of data into the destination QMS. The destination QMS may correspond to the destination QMS 202. The system 400 may correspond to the system 200.

The system 400 may be a computing device that has processing capabilities, such as a server, a desktop, a laptop, a tablet, a mobile phone, or the like. For instance, the system 400 may include a processing unit 402. The processing unit 402 may be, for example, a microprocessor, a microcomputer, a microcontroller, a digital signal processor, a central processing unit, a state machine, a logic circuitry, or a device that manipulates signals based on operational instructions. Among other capabilities, the processing unit 402 may fetch and execute computer-readable instructions stored in a memory 406, such as a volatile memory or a non-volatile memory, of the system 400.

The processing unit 402 may run at least one operating system and other applications and services. The system 400 can also include an interface and the memory 406. The processing unit 402, amongst other capabilities, may be configured to fetch and execute computer-readable instructions stored in the memory. The processing unit 402 may be implemented as one or more microprocessors, microcomputers, microcontrollers, digital signal processors, central processing units, state machines, logic circuitries, and/or any devices that manipulate signals based on operational instructions. The functions of the various elements shown in the figure, including any functional blocks labelled as “processing unit”, may be provided through the use of dedicated hardware as well as hardware capable of executing machine readable instructions.

When provided by the processing unit 402, the functions may be provided by a single dedicated processor, by a single shared processor, or by a plurality of individual processors, some of which may be shared. Moreover, explicit use of the term “processing unit” should not be construed to refer exclusively to hardware capable of executing machine readable instructions, and may implicitly include, without limitation, digital signal processor (DSP) hardware, network processor, application specific integrated circuit (ASIC), field programmable gate array (FPGA), read only memory (ROM) for storing machine readable instructions, random access memory (RAM), non-volatile storage. Other hardware, conventional and/or custom, may also be included.

The interface may include a variety of machine-readable instructions-based interfaces and hardware interfaces that allow the cloud communication device to interact with different entities, such as the processing unit 402. Further, the interface may enable the components of the system 400 to communicate with other cloud servers, web servers, and external repositories. The interface may facilitate multiple communications within a wide variety of networks and protocol types, including wired network, wireless networks, wireless Local Area Network (WLAN), RAN, satellite-based network, and the like.

The memory 406 may be coupled to the processing unit 402 and may, among other capabilities, provide data and instructions for generating different requests. The memory 406 can include any computer-readable medium known in the art including, for example, volatile memory, such as static random-access memory (SRAM) and dynamic random-access memory (DRAM), and/or non-volatile memory, such as read only memory (ROM), erasable programmable ROM, flash memories, hard disks, optical disks, and magnetic tapes. The memory 406 may include a database (not shown in FIG. 4) that may include data files, such as the data files 204. Further, the system 400 may include a display device. The display device may correspond to the display device of the system 400. The display device may display the UI.

Further, the system 400 may include one or more engines 404-1-404-8. The engines 404-1-404-8 may include routines, programs, objects, components, data structures, and the like, which perform particular tasks or implement particular abstract data types. Further, the engines 404-1-404-8 may be implemented in hardware, instructions executed by a processing unit, or by a combination thereof.

In an implementation, the engines 404-1-404-8 may be machine-readable instructions which, when executed by the processing unit, perform any of the described functionalities. The machine-readable instructions may be stored on an electronic memory device, hard disk, optical disk or other machine-readable storage medium or non-transitory medium. In one implementation, the machine-readable instructions can also be downloaded to the storage medium via a network connection.

The engines 404-1-404-8 may perform different functionalities. The engines 404-1-404-8 may include a parsing engine 404-1, a data type determination engine 404-2, an import strategy selection engine 404-3, a configuration element determination engine 404-4, a mapping engine 404-5, a configuration engine 404-6, a validation engine 404-7, and a report generation engine 404-8.

The parsing engine 404-1 may parse the one or more data files to extract a plurality of configuration elements in the standardized protocol format. The one or more data files may correspond to the one or more data files of the source QMS, such as the data files 104 of the source QMS 102. In an example, the parsing engine 404-1 may classify each field of the extracted configuration element according to a data type of the extracted configuration element.

The parsing engine 404-1 may identify complex fields that correspond to fields that have nested records. The parsing engine 404-1 may recursively process the identified complex fields to extract the nested records. The parsing engine 404-1 may identify fields corresponding to each of the extracted configuration elements that require audit trailing and may import audit trail definitions associated with the fields. Further, the parsing engine 404-1 may configure audit trail settings in the QMS based on the imported audit trail definitions.

The data type determination engine 404-2 may determine a data type of the each of the configuration elements based on metadata in the standardized protocol. The import strategy selection engine 404-3 may select an import strategy from a plurality of predefined import strategies based on the determined data type. For instance, each predefined import strategy may correspond to a data type.

The configuration element determination engine 404-4 may determine a configuration element of the destination QMS corresponding to each of the plurality of extracted configuration elements based on the selected import strategy. In particular, the configuration element determination engine 404-4 may determine a format corresponding to the configuration element of the destination QMS corresponding to each of the plurality of extracted configuration elements. In addition, the configuration element determination engine 404-4 may determine an import sequence based on an identification of the interdependencies and hierarchical relationships among the elements.

The mapping engine 404-5 may map each of the plurality of extracted configuration elements to the corresponding configuration element of the destination QMS. The mapping engine 404-5 may select an appropriate data type of the field in the destination QMS to map the extracted configuration elements.

In an example, the mapping engine 404-5 may allow manual mapping and automatic mapping of the extracted configuration elements. For instance, in the manual mapping, the mapping engine 404-5 may present a UI to a user for receiving selection from a user to map of the extracted configuration elements to a corresponding destination configuration element. In response, the mapping engine 404-5 may perform the mapping of the extracted configuration elements. In an example, the mapping engine 404-5 may receive selection from a user to perform automatic mapping of the extracted configuration elements. Based on the selection, the mapping engine 404-5 may perform automatic mapping of the extracted configuration elements.

In another example, the mapping engine 404-5 may determine if each of the extracted configuration elements is mapped to a corresponding configuration element of the destination QMS and may allow manual mapping of an extracted configuration element to a configuration element of the destination QMS based on the determination that the extracted configuration element is not automatically mapped to a corresponding configuration element of the destination QMS.

The configuration engine 404-6 may generate configuration scripts in response to the mapping and may configure the destination QMS by executing the configuration scripts. In an example, the configuration engine 404-6 may generate the configuration scripts based on the mapping and on the import sequence. The validation engine 404-7 may validate the configuration of the destination QMS to ensure compliance with predefined quality standards. The report generation engine 404-8 generate a report indicating the mapping and configuration based on the validation of the configuration. The report may include details of each configuration element mapped, format of the configuration elements in the source QMS, format of the configuration elements in the destination QMS, the option of the mapping selected by the user for each configuration element, a list of successfully migrated configuration elements in the destination QMS, and/or a list of configuration elements that failed the migration into the destination QMS.

FIGS. 5a-5c illustrate a method 500 for data migration between QMSs, according to an example implementation of the present subject matter. The order in which the method 500 is described is not intended to be construed as a limitation, and any number of the described method blocks may be combined in any order to implement the method 500, or an alternative method. Furthermore, the method 500 may be implemented by processor(s) or computing device(s) through any suitable hardware, non-transitory machine-readable instructions, or a combination thereof.

It may be understood that steps of the method 500 may be performed by programmed computing devices and may be executed based on instructions stored in a non-transitory computer readable medium. The non-transitory computer readable medium may include, for example, digital memories, magnetic storage media, such as magnetic disks and magnetic tapes, hard drives, or optically readable digital data storage media. In an example, the method 500 may be performed by the system 100 and the system 200 or the system 300 and the system 400. In particular, the method 500 may be performed by the processing unit 302 and the processing unit 402. Herein, migration of data between a source QMS and a destination QMS is explained. The source QMS may correspond to the source QMS 102 and the destination QMS may correspond to the destination QMS 202.

At step 502, it is determined if a User Interface (UI) has been displayed. The UI may be displayed on a display device of the system, such as the system 100 or the system 200. The UI may display an option to select the configuration data that is to be migrated from the source QMS to the destination QMS. For instance, assume that a medical device industry may have to migrate the data from a source QMS, such as Trackwise, to a destination QMS, such as Trackwise Digital. In an example, the configuration data may include one or more data files that include various configuration elements. The data files may be, for example, JSON-based. The data files may correspond to the data files 104 and the configuration elements may correspond to the configuration elements 106.

As an example, the configuration elements may include workflow definitions, object definitions, and permission set definitions. For instance, the medical device industry may include workflow definitions corresponding to consumer complaints received from users, various stages of quality check performed on medical devices manufactured by the medical device industry, various manufacturing processes for producing medical devices, and the like.

Further, the object definitions may include fields corresponding to consumer complaints, such as type of complaint, consumer id, and the like, fields corresponding to various stages of quality check on medical devices manufactured, such as fields corresponding to performance parameters of the medical devices, fields corresponding to compliance testing of the medical devices, and the like. The object definitions may also include types corresponding to each field, such as text, numeric, and the like. In addition, the object definitions may also include field attributes corresponding to the fields, such as read-only field, required field, pick list values corresponding to the field, and the like. For instance, the field attribute corresponding to the consumer Identity for a consumer complaint on a medical device may be a required field. The field attribute corresponding to a performance parameter of the medical device recorded may be a read-only field. The object definitions may also include audit trail configurations. For instance, some configuration elements may require audit trailing to adhere to regulatory requirements. The object definitions for such fields may also include audit trail configurations. For instance, the fields corresponding to purchase of medical devices may require audit trailing and may include attributes, such as time of purchase, location of the purchase, mode of delivery, mode of payment, and the like. In some scenarios, the object definitions may include presentation layouts for the fields, such as how to display details corresponding to the fields in the UI, and the like.

The permission set definitions may include read, write, and delete permissions for specific objects and fields. For example, a first quality control personnel may be provided with read, write, and delete access for fields corresponding to performance parameters of medical devices. A second quality control personnel may be provided with only read access for fields corresponding to performance parameters of medical devices. A first user, such as a person from a complain registration team, may be provided with access rights to initiate, progress, and/or approve workflow stages corresponding to receiving a consumer complaint from a user of medical devices. In some scenarios, the permission set definitions may include visibility rules for different section within an object. For instance, a first user may be able to view fields corresponding to performance parameters and compliance testing, whereas a second user may be able to view fields only corresponding to performance parameters. In some scenarios, the configuration data may include complex fields that may have nested records. In other words, the fields may have parent-child relationship and one field may be related to another field.

At step 502, if it is determined that the UI has been displayed, the method 500 may move to step 504. On the other hand, if it is determined that the UI has not been displayed, the method 500 may await till the UI has been displayed. At step 504, it may be determined if a selection of the configuration data been received. In particular, a user accessing the UI may select the configuration data that will have to be moved from the source QMS to the destination QMS. For instance, at a particular time, the medical device industry may not want to migrate the entire configuration data at once. Instead, the medical device industry may want to migrate the configuration data sequentially. In other words, the medical device industry may want to migrate configuration data corresponding to each type of medical device sequentially. Therefore, at step 504, it may be determined if the section of the configuration data has been made. For instance, assume that the medical device industry may want to migrate configuration data corresponding to the pacemakers. Therefore, the configuration data corresponding to the pacemakers may be selected for the migration.

At step 504, if it is determined that the selection of the configuration data is made, the method 500 may proceed to the step 506. On the other hand, if it is determined that the selection of the configuration data is not made, the method 500 may repeat the step 506. At step 506, a plurality of configuration elements of the selected configuration data may be extracted. The extracted configuration elements may correspond to the one or more of the configuration elements 106. For instance, from the selected configuration data corresponding to the pacemakers, the configuration elements may be extracted. The extracted configuration elements may include workflow stages, object definitions, permission set definitions corresponding to pacemakers. In other words, the workflow definitions corresponding to consumer complaints of the pacemakers received from hospitals, various manufacturing processes for producing pacemakers, various stages of quality check performed during manufacturing of the pacemakers, and the like.

Further, the object definitions may include fields, such as type of complaint, consumer identity, and the like, corresponding to the pacemakers, fields, shear testing parameters of components of the pacemakers, compression testing parameters of the components of the pacemakers, fields corresponding to electromagnetic interference on the pacemakers, and the like. The object definitions may also include types corresponding to each field, such as text (for example, for type of complaint), numeric (for example, for consumer identity), and the like. In addition, the object definitions may also include field attributes corresponding to the fields, such as read-only field (for example, for consumer identity), required field (for example, shear testing parameters), pick list values corresponding to the field (for example, for type of complaint), and the like. The object definitions may also include audit trail configurations, such as regarding purchase of the pacemakers. In some scenarios, the object definitions may include presentation layouts for the fields, such as how to display performance parameters of the pacemakers, complaints received on the pacemakers, and the like.

The permission set definitions may include read, write, and delete permissions for specific objects and fields, such as for fields corresponding to the electromagnetic interference testing, the shear testing, and the like. In some scenarios, the permission set definitions may include visibility rules for different sections within an object. For instance, a first registering a complaint regarding the pacemaker may be able to only register complaints and may not be able to view fields corresponding to performance testing. In scenarios where there are complex fields that have nested records, such complex fields in the configuration data may be identified and may be recursively processed to extract the nested records.

At step 508, it may be ascertained if data type of each extracted configuration element has been determined. For instance, for each configuration element, such as type of complaint, complaint identity, performance parameters, and the like, of the pacemakers, it may be ascertained if the data type is determined. The data type of the type of complaint may be, for example, text. The data type of the complaint identity and performance parameters may be numeric. Accordingly, it may be ascertained, if the data type of all the extracted configuration elements of the pacemakers is determined. At step 508, if it is ascertained that the data type of all the extracted configuration elements has been determined, the method 500 may proceed to step 510. On the other hand, if the data type of all the extracted configuration elements is not determined, then the method 500 may repeat the step 508.

At step 510, a transformation strategy may be selected based on the determined data type. The transformation strategy may be selected from a plurality of predefined transformation strategies. Each predefined transformation strategy may correspond to a data type. For instance, if the data type is text, a first predefined transformation strategy may be selected. If the data type is numeric, a second predefined transformation strategy may be selected. Each predefined transformation strategy may facilitate transformation of the configuration elements in a standardized protocol format. The standardized protocol may be a descriptor language that encapsulates elements of a quality control process. In other words, the standardized protocol may include various definitions and specifications that are to enable capturing of configuration elements corresponding to a quality control process. In other words, for each configuration element, the standardized protocol may define the format in which the configuration element is to be transformed to enable easy migration to the destination QMS. For instance, the standardized protocol may define the format in which the complaint type may have to be transformed. The standardized protocol may define the format in which the performance parameters will have to be transformed. The definition of the rules and specification of the standardized protocol may be based on the data type of the configuration element. In an example, the standardized protocol may be JSON-based.

At step 512, each configuration element may be transformed into the standardized protocol format according to the transformation strategy and the specification corresponding to the standardized protocol. For each extracted workflow definition, workflow stages and the corresponding field configurations may be determined. The determined workflow stages and the corresponding field configurations may be transformed to the standardized protocol format. Similarly, for each extracted object definition, field types, attributes, and presentation layouts may be identifying. The identified field types, attributes, and presentation layouts may be transformed to the standardized protocol format. Likewise, for each extracted permission set definition, user roles and associated access rights may be ascertained. The ascertained user roles and access rights may be transformed to the standardized protocol format. In addition, if the extracted configuration element includes complex fields that have nested records, related record information may be cached to optimize processing of the nested records. For instance, the complaint type, the complaint identity, the performance parameters, the compliance testing parameters of the pacemakers, and the like, may be transformed into the standardized protocol format. In an example, the transformation may include mapping a name of each field to a standardized protocol-compliant name. Further, a type of each field may be determined and metadata may be captured.

In an example, prior to the transformation, the completeness of the extracted configuration elements may be verified. For instance, it may be verified if all the configuration elements are extracted completely along with the corresponding field types, attributes, access rights, and the like.

At step 514, upon the transformation, one or more data files may be generated. The data files may be standardized protocol-complaint. The data files may include the transformed configuration elements that are in standardized protocol format. For instance, the one or more data files, which includes transformed complaint type, complaint identity, performance parameters, compliance testing parameters, and the like, may be generated. The one or more data files may be JSON-based. At step 516, the one or more data files may be stored for use, such as for the migration. The one or more data files may be stored in a memory of the system, such as the memory 306.

Referring to FIG. 5b, at step 518, one or more data files may be output in the standardized protocol format. The steps 502-518 may be performed by the system 100 or the system 300. The output data files may be used for the migration into the destination QMS.

At step 520, it may be determined if a selection corresponding to the destination QMS has been received. For instance, the UI may display options for selection of the destination QMS for a user. In response, the user may select the destination QMS. For instance, assume that the user has selected a cloud-based QMS, such as trackwise Digital, out of the options provided on the UI. At step 520, if it is determined that the selection has been received, the method 500 may move to the step 522. On the other hand, if it is determined that the selection has not been received, the method 500 may perform the step 520 till the selection is received.

At step 522, the destination QMS may be identified. In response to the selection of the user the destination QMS may be identified. For instance, based on the selection as trackwise Digital, the destination QMS may be identified as trackwise Digital.

At step 524, the one or more data files that were output may be parsed to extract the plurality of configuration elements. For instance, the data files that are in standardized protocol format may be parsed. The parsing of the one or more data files may enable extraction of the configuration elements, such as complaint type, complaint identity, performance parameters, compliance testing parameters, and the like. The extracted configuration elements may be in the standardized protocol format. In an example, to parse, complex fields may be identified and may be recursively processed to extract the nested records.

Further, in an example, during the parsing, each field of the extracted configuration element may be classified according to a data type of the field. At step 526, data type of each configuration element may be determined. In an example, the data type may be determined using the metadata corresponding to the configuration element. The data type of the complaint type, complaint identity, performance parameters, compliance testing parameters, and the like, may be determined. For instance, the data type of the complaint type may be text, the data type of the complaint identity may be numeric, the data type of the performance parameters may be numeric, and the like.

At step 528, based on the determined data type, an import strategy may be selected. The import strategy may be selected from a plurality of predefined import strategies. Each predefined import strategy may correspond to a data type. For instance, a first predefined import strategy may correspond to the data type of text. A second predefined import strategy may correspond to the data type of numeric. Each predefined import strategy may correspond to migration to a format corresponding to the destination QMS from the standardized protocol format.

At step 530, each configuration element may be transformed into a format compatible with the destination QMS based on the selected import strategy. For each extracted workflow definition, workflow stages and the corresponding field configurations may be determined. The determined workflow stages and the corresponding field configurations may be transformed from standardized protocol format to the destination format. Similarly, for each extracted object definition, field types, attributes, and presentation layouts may be identified. The identified field types, attributes, and presentation layouts may be transformed from the standardized protocol format to the destination format. Likewise, for each extracted permission set definition, user roles and associated access rights may be ascertained. The ascertained user roles and access rights may be transformed from the standardized protocol format to the destination format. As an example, the complaint type, the complaint identity, the performance parameters, the compliance testing parameters of the pacemakers, and the like, may be transformed from the standardized protocol format to the destination format.

At step 532, options for mapping of the transformed configuration elements may be presented via the UI. The UI may be presented on the display device, such as the display device of the system 200. The options for mapping may include automatic mapping and manual mapping. In the automatic mapping, the configuration elements may be mapped automatically based on predefined rules. The predefined rules may include mapping of the configuration elements to corresponding configuration elements having similar formats. For instance, a text field may be mapped to a string field of the destination QMS.

In the manual mapping, the options may be provided for a user, such as a configuration administrator, to select the configuration element in the destination QMS for each extracted configuration element in the standardized protocol format. In some scenarios, in the manual mapping, if an incorrect mapping is identified, correct configuration elements for mapping may be provided. In an example, in the manual mapping, options for creation of new configuration elements in the destination QMS may be provided to accommodate configuration elements that are not part of the destination QMS format.

Referring to FIG. 5c, at step 534, it may be determined if a selection corresponding to the options for mapping has been received. In an example, the user may select the option of manual mapping. In another example, the user may select the option of automatic mapping. At step 534, if it is determined that the selection corresponding to the options for mapping has been received, the method 500 may proceed to step 536. On the other hand, if it is determined that the selection corresponding to the options for mapping has not been received, the method 500 may repeat the step 534.

At step 536, each configuration element corresponding to the source QMS may be mapped to a corresponding configuration element in the destination QMS based on the selection. In response to the selection of the user to automatically map, each configuration element corresponding to the source QMS may be automatically mapped in the destination QMS based on the predefined rules, as explained earlier. For instance, a workflow definition may be mapped to the corresponding workflow definition in the destination QMS. The object definition may be mapped to a corresponding object definition in the destination QMS. The permission set definition may be mapped to a corresponding permission set definition in the destination QMS.

On the other hand, in case the user had selected the option of manual mapping, the user may manually map the extracted configuration element to a corresponding configuration element in the destination QMS. For instance, assume that the standardized protocol includes a configuration element with a float data type. The user may manually map to a corresponding configuration element with the float data type. In this regard, in the manual mapping, options may be provided to the user to map to the existing configuration element in the destination QMS. In response to the selection of the option to map to the existing configuration element, the user may be allowed to manually map to the corresponding configuration element in the destination QMS.

During the manual mapping, the user may select incorrect mapping options. For instance, the user may manually map a configuration element with the float data type with the configuration element with text data type. In such a scenario, the user may be provided with the options to correct the mapping or to continue with the selected mapping. For instance, the user may be provided with an option to map the configuration element with the text data type instead of the float data type. As another option, the user may be provided an option to continue with the mapping performed by the user (mapping of the configuration element with the text data type). In response to the selection by the user, the mapping may be performed.

In another example, a user may want to create a new configuration element instead of mapping to the existing configuration element in the destination QMS. In such an example, the user may be provided with the option of creating a new configuration element in the destination QMS. For instance, assume that a configuration element with Boolean data type is not available in the destination QMS. In such a scenario, the user may want to create a new configuration element. Therefore, the user may select the option of creating a new configuration element. In response to the user selection, the user may be allowed to create a new configuration element with the Boolean data type.

At step 538, the destination QMS may be configured based on the mapping. Configuration scripts may be generated in response to the mapping and the destination QMS may be configured by executing the configuration scripts. In other words, based on the options selected for the mapping and the mapping of the configuration elements in the destination QMS, the configuration scripts may be generated and the destination QMS may be configured with the appropriate configuration elements. For instance, based on the mapping, configuration scripts corresponding to configuration elements for the pacemakers may be generated and the destination QMS may be configured with the configuration elements for the pacemakers.

In an example, interdependencies and hierarchical relationships among the configuration elements may be identified. Based on the identification, an import sequence may be determined. The import sequence may indicate sequence in which each configuration element will have to be imported. For instance, the import sequence may indicate that performance parameters will have to be imported first and subsequently, compliance testing parameters will have to be imported and so on. The configuration scripts may be generated based on the mapping and the import sequence.

In an example, each field of the extracted configuration elements may be classified according to a data type thereof. Further, to map, an appropriate data type of the field in the destination QMS may be selected based on the classification. In an example, if there are fields that require audit trailing, such fields corresponding to each of the extracted configuration elements may be identified. In such scenarios, the configuration scripts may include audit trail definitions associated with the fields, which may be imported while executing the configuration scripts. Then, audit trail settings in the destination QMS may be configured based on the imported audit trail definitions.

At step 540, a report corresponding to the mapping may be generated and stored. The report may include details of each configuration element mapped, format of the configuration elements in the source QMS, format of the configuration elements in the destination QMS, the option of the mapping selected by the user for each configuration element, a list of successfully migrated configuration elements in the destination QMS, a list of configuration elements that failed the migration into the destination QMS, or a combination thereof. In an example, the steps 520-540 may be performed by the system 200 or the system 400.

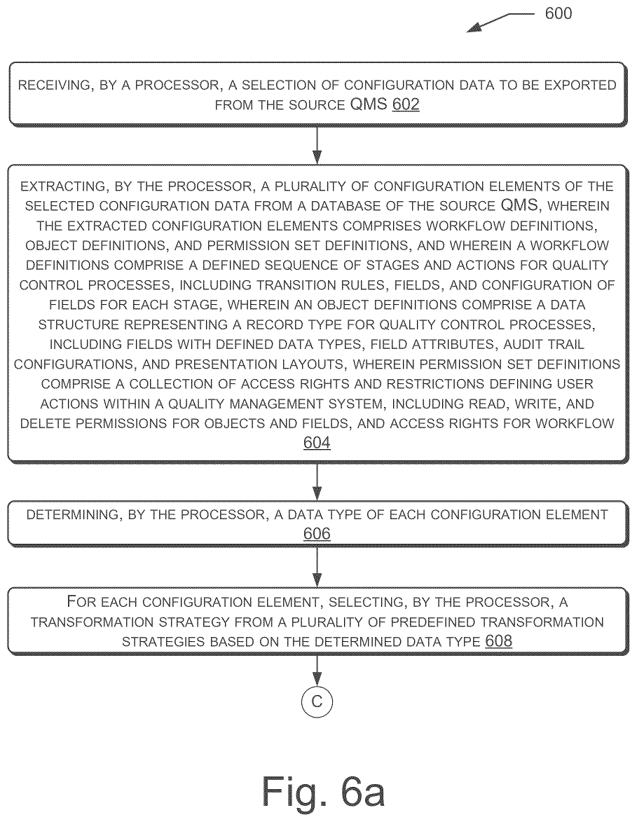

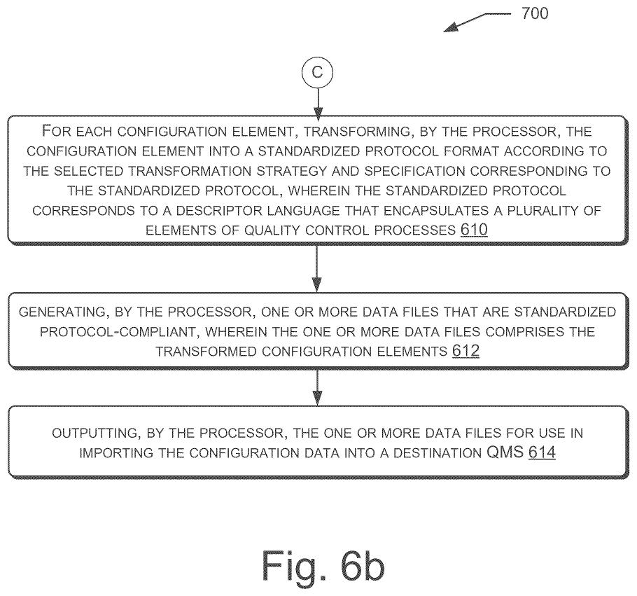

FIGS. 6a-6b illustrate a method 600 for data migration between QMSs, according to an example implementation of the present subject matter. The order in which the method 600 is described is not intended to be construed as a limitation, and any number of the described method blocks may be combined in any order to implement the method 600, or an alternative method. Furthermore, the method 600 may be implemented by processor(s) or computing device(s) through any suitable hardware, non-transitory machine-readable instructions, or a combination thereof.

It may be understood that steps of the method 600 may be performed by programmed computing devices and may be executed based on instructions stored in a non-transitory computer readable medium. The non-transitory computer readable medium may include, for example, digital memories, magnetic storage media, such as magnetic disks and magnetic tapes, hard drives, or optically readable digital data storage media. In an example, the method 600 may be performed by the system 100 or the system 300. In particular, the method 600 may be performed by the processing unit 302. Herein, the migration of the data from the source QMS is explained. The source QMS may correspond to the source QMS 102.

Referring to FIG. 6a, at step 602, a selection of configuration data to be exported from the source QMS may be received. At step 604, a plurality of configuration elements of the selected configuration data may be extracted from a database of the source QMS. The extracted configuration elements may include workflow definitions, object definitions, and permission set definitions. The workflow definitions may include a defined sequence of stages and actions for quality control processes, including transition rules, fields, and configuration of fields for each stage. The object definitions may include a data structure representing a record type for quality control processes, including fields with defined data types, field attributes, audit trail configurations, and presentation layouts. The permission set definitions comprise a collection of access rights and restrictions defining user actions within a quality management system, including read, write, and delete permissions for objects and fields, and access rights for workflow.

At step 606, determining a data type of each of the configuration element. At step 608, a transformation strategy from a plurality of predefined transformation strategies may be selected for each configuration element based on the determined data type.

Referring to FIG. 6b, at step 610, each configuration element may be transformed into a standardized protocol format according to the selected transformation strategy and specification corresponding to the standardized protocol. The standardized protocol may correspond to a descriptor language that encapsulates a plurality of elements of quality control processes. The standardized protocol may correspond to a JSON-based descriptor language.

At step 612, one or more data files that are standardized protocol-compliant may be generated. The one or more data files may include the transformed configuration elements. At step 614, the one or more data files for use in importing the configuration data into a destination QMS may be output. The destination QMS may correspond to the destination QMS 202.

In an example, the transformation of the configuration element may include applying a set of transformation rules that convert the configuration element into a standardized JSON structure. In an example, the set of transformation rules may include mapping a name of each field to a standardized protocol-compliant name and determining a type of each field. In addition, the set of transformation rules may include capturing metadata associated with each field.

In an example, the method 600 may include, for each extracted workflow definition, determining workflow stages and the corresponding field configurations. The determined workflow stages and the corresponding field configurations may be transformed to the standardized protocol format.

For each extracted object definition, the method 600 may include identifying field types, attributes, and presentation layouts and transforming the identified field types, attributes, and presentation layouts to the standardized protocol format. For each extracted permission set definition, the method 600 may include ascertaining user roles and associated access rights. The method 600 may include transforming the ascertained user roles and access rights to the standardized protocol format. If the extracted configuration element comprises complex fields that have nested records, the method 600 may include caching related record information to optimize processing of the nested records.

In an example, the method 600 may include identifying complex fields in the configuration data. The complex fields may correspond to fields that have nested records. The identified complex fields may be recursively processed to extract the nested records. In an example, prior to the transformation of the configuration element, the method 600 may include verifying, by the processor, completeness of the extracted configuration element.

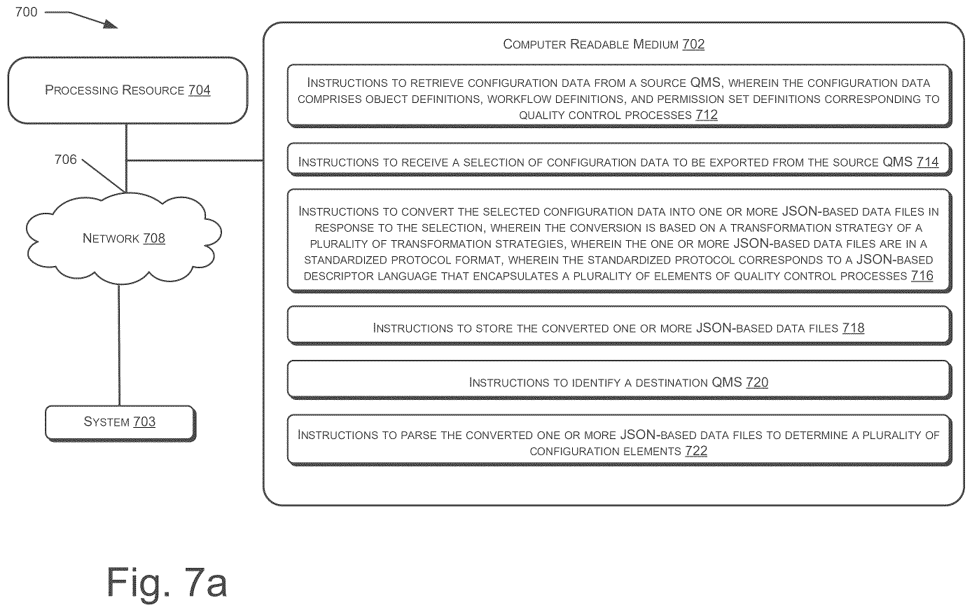

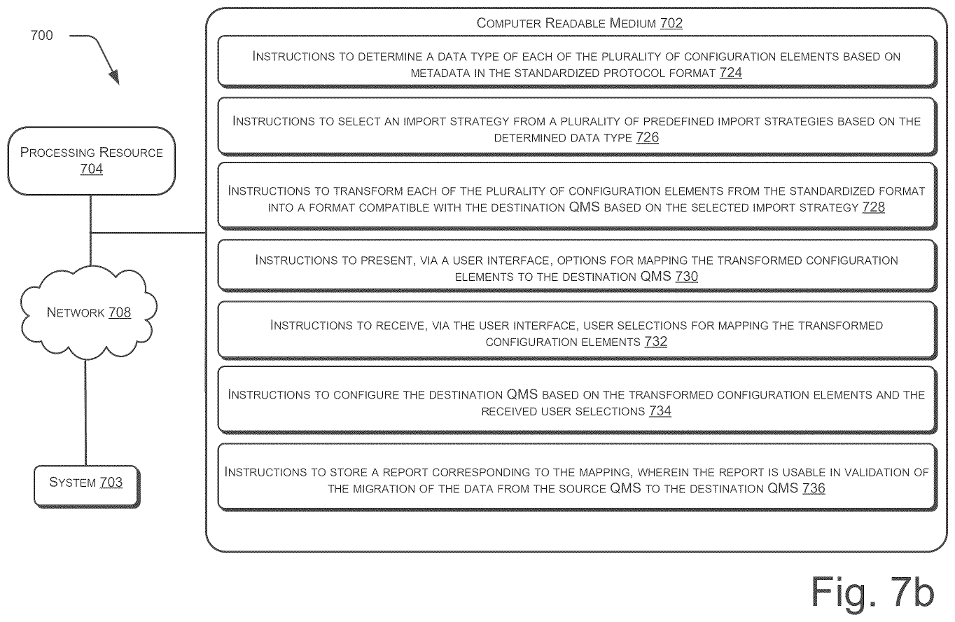

FIGS. 7a-7b illustrate a computing environment 700, implementing a non-transitory computer-readable medium 702 for data migration between QMSs, according to an example implementation of the present subject matter. In an example, the non-transitory computer-readable medium 702 may be utilized by the system 703. The system 703 may correspond to the system 100, the system 200, the system 300, and/or the system 400. The system 703 may be implemented in a public networking environment or a private networking environment. In an example, the computing environment 700 may include a processing resource 704 communicatively coupled to the non-transitory computer-readable medium 702 through a communication link 706.

In an example, the processing resource 704 may be implemented in a device, such as the system 703. The non-transitory computer-readable medium 702 may be, for example, an internal memory device of the system 703 or an external memory device. In an implementation, the communication link 706 may be a direct communication link, such as any memory read/write interface. In another implementation, the communication link 706 may be an indirect communication link, such as a network interface. In such a case, the processing resource 704 may access the non-transitory computer-readable medium 702 through a network 708. The network 708 may be a single network or a combination of multiple networks and may use a variety of different communication protocols. The processing resource 704 and the non-transitory computer-readable medium 702 may also be communicatively coupled to the system 703 over the network 708.

In an example implementation, the non-transitory computer-readable medium 702 includes a set of computer-readable instructions to migrate data between QMSs. The set of computer-readable instructions can be accessed by the processing resource 704 through the communication link 706 and subsequently executed to perform acts to migrate data between QMSs. In particular, the data may be migrated from a source QMS, such as the source QMS 102, and a destination QMS, such as the destination QMS 202.

Referring to FIG. 7a, in an example, the non-transitory computer-readable medium 702 includes instructions 712 to retrieve configuration data from the source QMS. The configuration data may include object definitions, workflow definitions, and permission set definitions corresponding to quality control processes.

The non-transitory computer-readable medium 702 includes instructions 714 to receive a selection of configuration data to be exported from the source QMS. The non-transitory computer-readable medium 702 includes instructions 716 to convert the selected configuration data into one or more JSON-based data files in response to the selection. The conversion may be based on a transformation strategy of a plurality of transformation strategies. The one or more JSON-based data files may be in a standardized protocol format. The standardized protocol corresponds to a JSON-based descriptor language that encapsulates a plurality of elements of quality control processes.

The non-transitory computer-readable medium 702 includes instructions 718 to store the converted one or more JSON-based data files. The non-transitory computer-readable medium 702 includes instructions 720 to identify a destination QMS. The non-transitory computer-readable medium 702 includes instructions 722 to parse the converted one or more JSON-based data files to determine a plurality of configuration elements. Referring to FIG. 7b, the non-transitory computer-readable medium 702 includes instructions 724 to determine a data type of each of the plurality of configuration elements based on metadata in the standardized protocol format. The non-transitory computer-readable medium 702 includes instructions 726 to select an import strategy from a plurality of predefined import strategies based on the determined data type. The non-transitory computer-readable medium 702 includes instructions 728 to transform each of the plurality of configuration elements from the standardized format into a format compatible with the destination QMS based on the selected import strategy. The non-transitory computer-readable medium 702 includes instructions 730 to present, via a user interface, options for mapping the transformed configuration elements to the destination QMS.

The non-transitory computer-readable medium 702 includes instructions 732 to receive, via the user interface, user selections for mapping the transformed configuration elements. The non-transitory computer-readable medium 702 includes instructions 734 to configure the destination QMS based on the transformed configuration elements and the received user selections. The non-transitory computer-readable medium 702 includes instructions 736 to store a report corresponding to the mapping. The report may be usable in validation of the migration of the data from the source QMS to the destination QMS. The report may include details of each configuration element mapped, format of the configuration elements in the source QMS, format of the configuration elements in the destination QMS, the option of the mapping selected by the user for each configuration element, a list of successfully migrated configuration elements in the destination QMS, a list of configuration elements that failed the migration into the destination QMS, or a combination thereof. In an example, prior to storing the report, the instructions may be executable by the processing resource to generate the report corresponding to the migration.

In an example, the non-transitory computer-readable medium 702 includes instructions to determine a data type of each of the plurality of configuration elements in the configuration data and to select the transformation strategy from a plurality of predefined transformation strategies based on the determined data type. Further, the non-transitory computer-readable medium 702 includes instructions to generate one or more JSON-based data files in the standardized protocol format according to the selected transformation strategy and predefined protocol specifications.

In an example, the options for mapping the transformed configuration elements may include mapping to a configuration element existing in the destination QMS and creating a new element in the destination QMS for the mapping. In response to the receipt of the user selection of mapping to a configuration element existing in the destination QMS, the instructions may be executable by the processing resource to map the transformed configuration elements to a corresponding configuration element in the destination QMS. In response to the receipt of the user selection of the option of creating a new element in the destination QMS for the mapping, a new configuration element may be created in the destination QMS. Further, the transformed configuration element may be mapped to the new configuration element.

The present subject matter enables simple, easy, and efficient migration of data between QMSs. Further, the present subject matter ensures accurate migration of data and enhanced compliance and data integrity. The present subject matter facilitates handling highly customized QMSs. The present subject matter also reduces substantial manual intervention required for validation of the migration. The present subject matter facilitates smooth and compliant migration between QMSs. The present subject matter allows migration between different QMS systems without needing to develop entirely new tools for each system pair. In other words, the present subject matter eliminates work effort of developing migration utilities, as only the export or import component needs to be developed for a new system.

Although examples and implementations of present subject matter have been described in language specific to structural features and/or methods, it is to be understood that the present subject matter is not necessarily limited to the specific features or methods described. Rather, the specific features and methods are disclosed and explained in the context of a few example implementations of the present subject matter.

1. A system for migrating data into a destination Quality Management System (QMS), the system comprising:
a processing unit to:
receive one or more data files in a standardized protocol format, wherein the one or more data files are exported from a source QMS, wherein the one or more data files comprises a configuration metadata of the source QMS, wherein the standardized protocol corresponds to a descriptor language that encapsulates a plurality of elements of quality control processes;
parse the received one or more data files to extract a plurality of configuration elements in the standardized protocol format, wherein the plurality of configuration elements comprises a plurality of QMS configuration artifacts;
determine a data type of the each of the configuration elements based on the configuration metadata in the standardized protocol;
select an import strategy from a plurality of predefined import strategies based on the determined data type, wherein each of the plurality of predefined import strategies defines how a configuration element of the plurality of configuration elements is instantiated within a pre-existing configuration schema of the destination QMS;
determine a configuration element of the destination QMS corresponding to each of the plurality of extracted configuration elements based on the selected import strategy;
map each of the plurality of extracted configuration elements to the corresponding configuration element of the destination QMS based on the determination;
generate configuration scripts in response to the mapping;
configure the destination QMS by executing the configuration scripts;
validate the configuration of the destination QMS to ensure compliance with predefined quality standards; and
generate a report indicating the mapping and configuration based on the validation of the configuration.

2. The system as claimed in claim 1, wherein the processing unit is to:
determine an import sequence based on an identification of interdependencies and hierarchical relationships among the configuration elements; and
generate the configuration scripts based on the mapping and on the import sequence.

3. The system as claimed in claim 1, wherein the plurality of extracted configuration elements comprises workflow definitions, object definitions, and permission set definitions, and wherein a workflow definitions comprise a defined sequence of stages and actions for quality control processes, including transition rules, fields, and configuration of fields for each stage, wherein an object definitions comprise a data structure representing a record type for quality control processes, including fields with defined data types, field attributes, audit trail configurations, and presentation layouts, wherein permission set definitions comprise a collection of access rights and restrictions defining user actions within a quality management system, including read, write, and delete permissions for objects and fields, and access rights for workflow.

4. The system as claimed in claim 1, wherein, to parse, the processing unit is to:
classify each field of the extracted configuration element according to a data type thereof; and
wherein to map, the processing unit is to select an appropriate data type of the field in the destination QMS based on the classification.

5. The system as claimed in claim 1, wherein, to parse, the processing unit is to:
identify complex fields, wherein the complex fields correspond to fields that have nested records; and
recursively process the identified complex fields to extract the nested records.

6. The system as claimed in claim 1, wherein the processing unit is to:
identify fields corresponding to each of the extracted configuration elements that require audit trailing;
import audit trail definitions associated with the fields; and
configure audit trail settings in the QMS based on the imported audit trail definitions.

7. The system as claimed in claim 1, wherein the processing unit is to:
determine if each of the extracted configuration elements is mapped to a corresponding configuration element of the destination QMS; and
allow manual mapping of an extracted configuration element to a configuration element of the destination QMS based on the determination that the extracted configuration element is not automatically mapped to a corresponding configuration element of the destination QMS.

8. The system as claimed in claim 1, wherein the destination QMS is one cloud-based QMS and on-premise-based QMS.

9. A method for migrating data between a source Quality Management System (QMS) and a destination QMS, the method comprising:
receiving, by a processor, a selection of configuration data to be exported from the source QMS;
extracting, by the processor, a plurality of configuration elements of the selected configuration data from a database of the source QMS, wherein the extracted configuration elements comprises workflow definitions, object definitions, and permission set definitions, and wherein a workflow definitions comprise a defined sequence of stages and actions for quality control processes, including transition rules, fields, and configuration of fields for each stage, wherein an object definitions comprise a data structure representing a record type for quality control processes, including fields with defined data types, field attributes, audit trail configurations, and presentation layouts, wherein permission set definitions comprise a collection of access rights and restrictions defining user actions within a quality management system, including read, write, and delete permissions for objects and fields, and access rights for workflow;
for each of the plurality of extracted configuration elements:
determining, by the processor, a data type of the configuration element;
selecting, by the processor, a transformation strategy from a plurality of predefined transformation strategies based on the determined data type;
transforming, by the processor, the configuration element into a standardized protocol format according to the selected transformation strategy and specification corresponding to the standardized protocol, wherein the standardized protocol corresponds to a descriptor language that encapsulates a plurality of elements of quality control processes;
generating, by the processor, one or more data files that are standardized protocol-compliant, wherein the one or more data files comprises the transformed configuration elements, and wherein the one or more data files further comprises configuration metadata of the source QMS; and
outputting, by the processor, the one or more data files exported from the source QMS for use in importing the configuration data into a destination QMS
parsing, at the destination QMS, the one or more data files to extract a plurality of configuration elements in the standardized protocol format, wherein the plurality of configuration elements comprises a plurality of QMS configuration artifacts
determining a data type of each of the configuration elements based on the configuration metadata in the standardized protocol
selecting an import strategy from a plurality of predefined import strategies based on the determined data type, wherein each of the plurality of predefined import strategies defines how a configuration element of the plurality of configuration elements is instantiated within a pre-existing configuration schema of the destination QMS; and
configuring the destination QMS based on the selected import strategy.

10. The method as claimed in claim 9, wherein the standardized protocol corresponds to a JavaScript Object Notation (JSON)-based descriptor language.

11. The method as claimed in claim 9, wherein the transformation of the configuration element comprises applying, by the processor, a set of transformation rules that convert the configuration element into a standardized JSON structure.

12. The method as claimed in claim 11, wherein the set of transformation rules comprises:
mapping, by the processor, a name of each field to a standardized protocol-compliant name;
determining, by the processor, a type of each field; and
capturing, by the processor, metadata associated with each field.

13. The method as claimed in claim 9, wherein the method comprises:
for each extracted workflow definition:
determining, by the processor, workflow stages and the corresponding field configurations; and
transforming, by the processor, the determined workflow stages and the corresponding field configurations to the standardized protocol format;
for each extracted object definition:
identifying, by the processor, field types, attributes, and presentation layouts; and
transforming, by the processor, the identified field types, attributes, and presentation layouts to the standardized protocol format;
for each extracted permission set definition:
ascertaining, by the processor, user roles and associated access rights; and
transforming, by the processor, the ascertained user roles and access rights to the standardized protocol format.

14. The method as claimed in claim 9, wherein if the extracted configuration element comprises complex fields that have nested records, the method comprises caching, by the processor, related record information to optimize processing of the nested records.

15. The method as claimed in claim 9, comprising:
identifying, by the processor, complex fields in the configuration data, wherein the complex fields correspond to fields that have nested records; and
recursively processing, by the processor, the identified complex fields to extract the nested records.

16. The method as claimed in claim 9, wherein prior to the transformation of the configuration element, the method comprises verifying, by the processor, completeness of the extracted configuration element.

17. A non-transitory computer-readable medium comprising instructions for migrating data between Quality Management Systems (QMSs), the instructions being executable by a processing resource to:
retrieve configuration data from a source QMS, wherein the configuration data comprises object definitions, workflow definitions, and permission set definitions corresponding to quality control processes;
receive a selection of configuration data to be exported from the source QMS;
convert the selected configuration data into one or more JSON-based data files in response to the selection, wherein the conversion is based on a transformation strategy of a plurality of transformation strategies, wherein the one or more JSON-based data files are in a standardized protocol format, wherein the standardized protocol corresponds to a JSON-based descriptor language that encapsulates a plurality of elements of quality control processes, and wherein the one or more JSON-based data files are exported from the source QMS and comprise configuration metadata of the source QMS;
store the converted one or more JSON-based data files;
identify a destination QMS;
parse the converted one or more JSON-based data files to determine a plurality of configuration elements, wherein the plurality of configuration elements comprises a plurality of QMS configuration artifacts;
determine a data type of each of the plurality of configuration elements based on metadata in the standardized protocol format;
select an import strategy from a plurality of predefined import strategies based on the determined data type, wherein each of the plurality of predefined import strategies defines how a configuration element of the plurality of configuration elements is instantiated within a pre-existing configuration schema of the destination QMS;
transform each of the plurality of configuration elements from the standardized format into a format compatible with the destination QMS based on the selected import strategy;
present, via a user interface, options for mapping the transformed plurality of configuration elements to the destination QMS;
receive, via the user interface, user selections for mapping the transformed plurality of configuration elements;
configure the destination QMS based on the transformed plurality of configuration elements and the received user selections; and
store a report corresponding to the mapping, wherein the report is usable in validation of the migration of the data from the source QMS to the destination QMS.

18. The non-transitory computer-readable medium of claim 17, the instructions being executable by the processing resource to:
determine a data type of each of the plurality of configuration elements in the configuration data;
select the transformation strategy from a plurality of predefined transformation strategies based on the determined data type; and
generate one or more JSON-based data files in the standardized protocol format according to the selected transformation strategy and predefined protocol specifications.

19. The non-transitory computer-readable medium of claim 17, wherein the options for mapping the transformed plurality of configuration elements comprises mapping to a configuration element existing in the destination QMS and creating a new element in the destination QMS for the mapping, the instructions being executable by the processing resource to:
in response to the receipt of the user selection of mapping to a configuration element existing in the destination QMS, map each of the transformed plurality of configuration elements to a corresponding configuration element in the destination QMS; and
in response to the receipt of the user selection of the option of creating a new element in the destination QMS for the mapping:
create a new configuration element in the destination QMS; and
map a transformed configuration element of the plurality of transformed configuration elements to the new configuration element.

20. The non-transitory computer-readable medium of claim 17, wherein prior to storing the report, the instructions being executable by the processing resource to generate the report corresponding to the migration, wherein the report comprises details of each configuration element mapped, format of the configuration elements in the source QMS, format of the configuration elements in the destination QMS, the option of the mapping selected by the user for each configuration element, a list of successfully migrated configuration elements in the destination QMS, a list of configuration elements that failed the migration into the destination QMS, or a combination thereof.
